(19) United States
(12) Patent Application Publication
(10) Pub. No.: US 2018/0245551 A1
(43) Pub. Date: Aug. 30, 2018

(54) INTAKE PIPE SUPPORTING STRUCTURE

(71) Applicant: HONDA MOTOR CO., LTD., Tokyo (JP)

(72) Inventor: Tamaki Watanabe, Wako-shi (JP)

(73) Assignee: HONDA MOTOR CO., LTD., Tokyo (JP)

(21) Appl. No.: 15/904,513

(22) Filed: Feb. 26, 2018

(30) Foreign Application Priority Data
Feb. 27, 2017 (JP) 2017-034522

(51) Int. Cl. F02M 35/10; F02B 77/08

(52) U.S. Cl. CPC F02M 35/10085; B60T 17/088; F02B 77/08

(57) ABSTRACT

A bracket provided on an engine body to support an intake pipe includes: a mounting part mounted on the engine body; and leg parts protruding from the mounting part to be fastened to the intake pipe, and the leg parts include brittle parts that are broken when a load is input from a brake member to the intake pipe. Accordingly, when the engine body is moved back and the intake pipe is brought into contact with the brake member due to a front-side collision of a vehicle and the intake pipe is pushed forward by a reaction load from the brake member, the leg parts are broken at the brittle parts and the intake pipe is thus separated from the mounting part of the bracket.

### CROSS REFERENCES TO RELATED APPLICATIONS

The present application claims priority under 35 U.S.C. § 119 to Japanese Patent Application No. 2017-034522, filed Feb. 27, 2017, entitled “INTAKE PIPE SUPPORTING STRUCTURE.” The contents of this application are incorporated herein by reference in their entirety.

### TECHNICAL FIELD

The present disclosure relates to an intake pipe supporting structure equipped with: a bracket that is provided on an engine body; an intake pipe that extends in a front-rear direction while being supported by the bracket; and a brake member that is provided on a dash panel so as to be located behind the intake pipe.

### BACKGROUND

There is publicly known in Japanese Patent Application Publication No. 2007-84041 a structure in which a master cylinder supported on a front face of a dash panel is provided at its front end with a guide part having an inclined face and this guide part faces a battery disposed ahead of the master cylinder. With this structure, when a vehicle collides at its front and the battery is moved back, the battery is brought into contact with the inclined face of the guide part and moves the master cylinder inward in a vehicle-widthwise direction, whereby the master cylinder is prevented from moving toward a vehicle compartment located therebehind and the battery is moved outward in the vehicle-widthwise direction so as to be distanced from the engine.

Besides, there is publicly known in Japanese Patent Application Publication No. Hei 4-345529 a structure for shortening the front overhang of a vehicle, in which a master cylinder supported on a front face of a dash panel is disposed with its front end inclined upward and an engine is installed transversely ahead of the master cylinder while its upper part is inclined rearward so as not to interfere with the master cylinder.

### SUMMARY

Meanwhile, according to the present inventor, in the case where a brake member such as a master cylinder is disposed behind an intake pipe that is supported by an engine installed in a front part of a vehicle, when the engine is moved back by a collision load generated due to a front-side collision of the vehicle, the intake pipe interferes with the master cylinder and the intake pipe is pushed back forward by receiving a reaction load from the master cylinder, which might adversely affect an intake-pipe supporting part of the engine. This can be avoided by changing the layout so that the intake pipe and the brake member may not interfere with each other, but it is difficult to change the layout of the intake pipe and the brake member in a narrow engine compartment.

It is preferable to protect components around a bracket, which supports an intake pipe of an engine, when the intake pipe interferes with a brake member due to a front-side collision of a vehicle.

First aspect of the embodiments provides an intake pipe supporting structure including: a bracket that is provided on an engine body; an intake pipe that extends in a front-rear direction while being supported by the bracket; and a brake member that is provided on a dash panel so as to be located behind the intake pipe, the structure being characterized in that the bracket is composed of: a mounting part that is mounted on the engine body; and a leg part that protrudes from the mounting part and is fastened to the intake pipe, and the leg part includes a brittle part that is broken when a load is input from the brake member to the intake pipe.

Second aspect provides the brittle part is a corner part that is formed on a rear side of a portion of the leg part where the leg part is connected to the mounting part.

Third aspect provides the brittle part is a constriction part where a cross-sectional area of the leg part is reduced locally.

Fourth aspect provides the leg part has an L-shaped cross-section composed of: a first portion that extends in the front-rear direction; and a second portion that extends from a front end of the first portion in a direction orthogonal to the front-rear direction.

Fifth aspect provides the leg part is composed of a first leg part on a front side thereof and a second leg part on a rear side thereof, and the first leg part and the second leg part each include the brittle part.

Sixth aspect provides the second leg part is longer than the first leg part.

Seventh aspect provides one of the first leg part and the second leg part extends in a vertical direction from the mounting part, and the other extends in a lateral direction from the mounting part.

Eighth aspect provides the bracket is made of aluminum.

For example, a high-pressure fuel pump base 14 of an embodiment corresponds to the engine body of the present disclosure, a first leg part 26 and a second leg part 27 of the embodiment correspond to the leg part of the present disclosure, and a corner part 26d and a constriction part 27d of the embodiment correspond to the brittle part of the present disclosure.

According to the first aspect, the bracket provided on the engine body to support the intake pipe is composed of: the mounting part mounted on the engine body; and the leg parts protruding from the mounting part to be fastened to the intake pipe, and the leg parts include the brittle parts that are broken when a load is input from the brake member to the intake pipe. Accordingly, when the engine body is moved back and the intake pipe is brought into contact with the brake member due to a front-side collision of a vehicle and the intake pipe is pushed forward by a reaction load from the brake member, the leg parts are broken at the brittle parts and the intake pipe is thus separated from the mounting part of the bracket. Thereby, components around the mounting part of the bracket of the engine body can be protected from being damaged.

Further, according to the second aspect, the brittle part is the corner part that is formed on the rear side of the portion of the leg part where the leg part is connected to the mounting part. Thus, it is possible to let stress concentrate on the corner part to facilitate its breakage when the intake pipe is pushed forward by a reaction load generated due to a front-side collision of the vehicle.

Further, according to the third aspect, the brittle part is the constriction part where the cross-sectional area of the leg part is reduced locally. Thus, it is possible to let stress concentrate on the constriction part to facilitate its breakage when the intake pipe is pushed forward by a reaction load generated due to a front-side collision of the vehicle.

Further, according to the fourth aspect, the leg part has the L-shaped cross-section composed of: the first portion that extends in the front-rear direction; and the second portion that extends from the front end of the first portion in a direction orthogonal to the front-rear direction. Accordingly, with this L-shaped cross-section, it is possible to increase the strength of the leg part while suppressing an increase of weight, and thus to increase its rigidity to support the intake pipe. Moreover, it is possible to let a large tensile load act on a rear edge of the first portion, extending in the front-rear direction in cross-section, to facilitate its breakage when the intake pipe is pushed forward by a reaction load generated due to a front-side collision of the vehicle.

Further, according to the fifth aspect, the leg part is composed of the first leg part on the front side thereof and the second leg part on the rear side thereof, and the first leg part and the second leg part each include the brittle part. Thus, it is possible to increase the rigidity of the leg part to support the intake pipe by displacing the fastening points of the first and second leg parts relative to the intake pipe from each other in the front-rear direction, and to reliably break the first and second leg parts at their brittle parts.

Further, according to the sixth aspect, the second leg part is longer than the first leg part. Thus, when the intake pipe is pushed forward by a reaction load generated due to a front-side collision of the vehicle, the second leg part being the longer one is broken first by letting a large bending moment act thereon and then the first leg part being the shorter one is broken by letting the reaction load concentrate thereon, thereby making it possible to break the first and second leg parts reliably.

Further, according to the seventh aspect, one of the first leg part and the second leg part extends in the vertical direction from the mounting part, and the other extends in the lateral direction from the mounting part. Thus, it is possible to further increase the rigidity of the leg part to support the intake pipe by displacing the fastening points of the first and second leg parts relative to the intake pipe from each other not only in the front-rear direction but also in the vertical direction or in the lateral direction.

Further, according to the eighth aspect, the bracket is made of aluminum. Thus, it is possible to break the leg part further reliably thanks to the high brittleness of aluminum.

### BRIEF DESCRIPTION OF THE DRAWINGS

FIG. 1 is a left side view of an in-line multi-cylinder engine installed in an engine compartment.

FIG. 2 is a view seen in the direction of arrow 2 in FIG. 1.

FIG. 3 is a view seen in the direction of arrow 3 in FIG. 2.

FIG. 4 is a view seen in the direction of arrow 4 in FIG. 2.

FIGS. 5A to 5C are unit diagrams of a bracket.

FIG. 6 is an explanatory view corresponding to FIG. 2, illustrating its operation at the time of collision.

### DETAILED DESCRIPTION

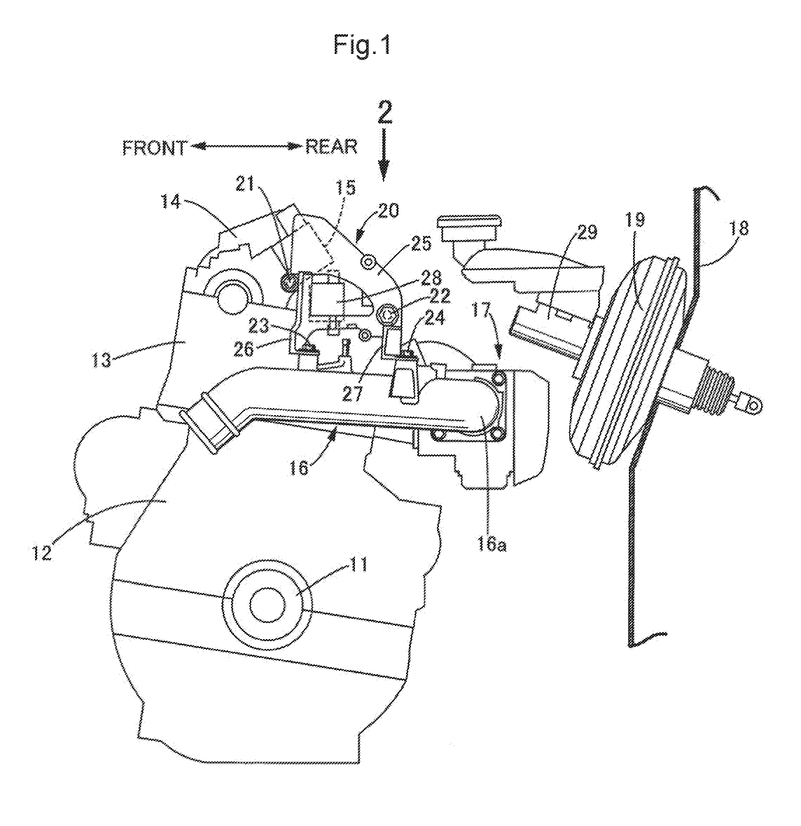

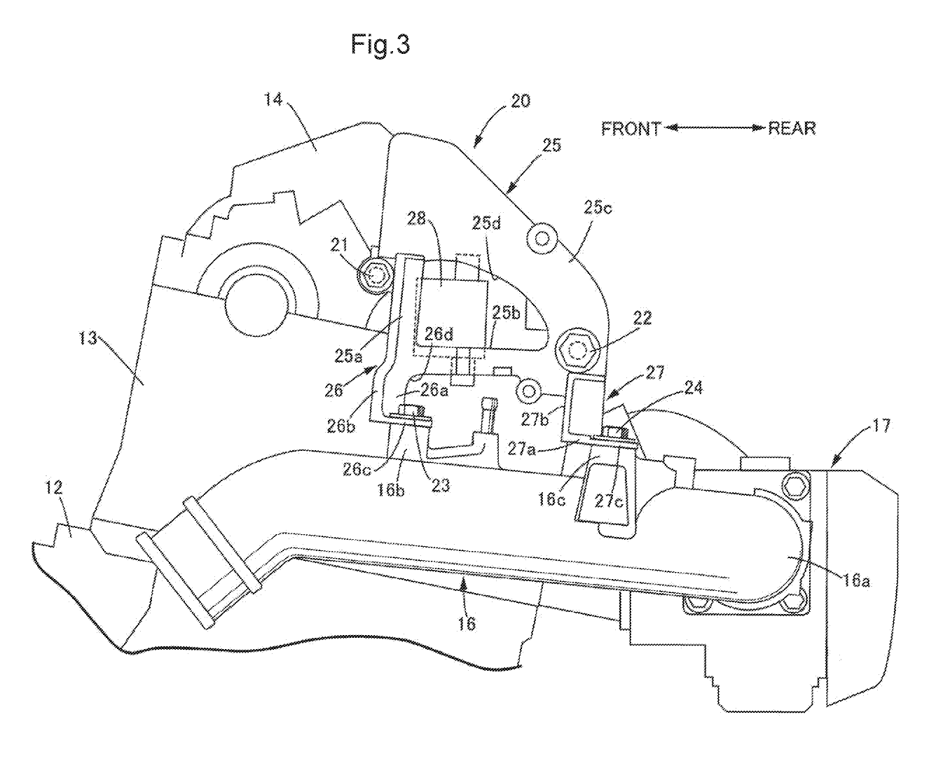

Hereinbelow, an embodiment of the present disclosure is described based on FIGS. 1 to 6. Note that, throughout this specification, a front-rear direction, a lateral direction, and a vertical direction are defined based on an occupant sitting on a driver's seat.

As illustrated in FIG. 1, an in-line multi-cylinder engine is installed transversely in an engine compartment of an automobile with a crankshaft 11 laid in the lateral direction along the engine, and includes: a cylinder block 12; a cylinder head 13 that is coupled to an upper face of the cylinder block 12; and a high-pressure fuel pump base 14 that is coupled to a left end part of an upper face of the cylinder head 13. A high-pressure fuel pump 15 that pressurizes fuel and feeds it to a fuel delivery pipe is mounted on the high-pressure fuel pump base 14.

An intake pipe 16 is disposed so as to extend in the front-rear direction along a left side face of the cylinder head 13. The front end of the intake pipe 16 is connected to a turbocharger (not illustrated), whereas the rear end of the intake pipe 16 bends at a right angle at a bend part 16a to be connected to a throttle valve 17 that is placed on a rear face of the cylinder head 13. A circular negative-pressure booster 19 is supported on a dash panel 18 constituting a rear wall of the engine compartment, and a master cylinder 29 protrudes forward and upward from the center of the negative-pressure booster 19. When seen in the front-rear direction, the bend part 16a at the rear end of the intake pipe 16 overlaps a lower part of the negative-pressure booster 19 located behind the bend part.

A bracket 20 which is an aluminum casting member is fastened, at its upper part, to a left side face of the high-pressure fuel pump base 14 with two bolts 21, 22. The intake pipe 16 is fastened, at its upper part, to the bracket 20 at its lower part with two bolts 23, 24, and thereby the intake pipe 16 is hung from and supported by the high-pressure fuel pump base 14 via the bracket 20.

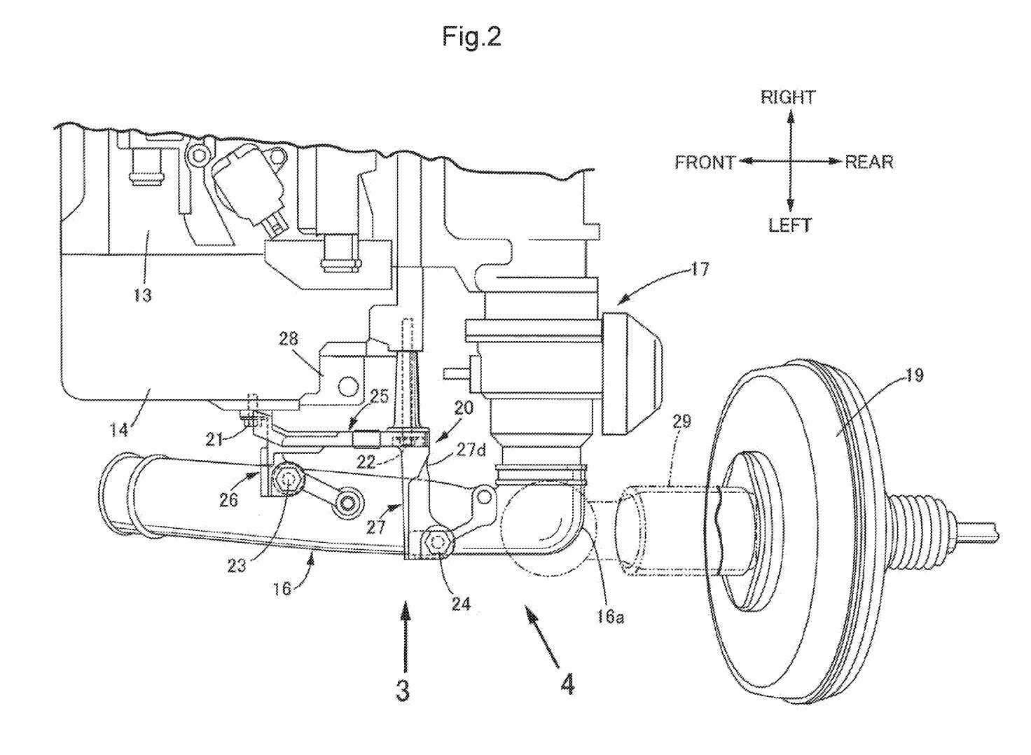

Next, the structure of the bracket 20 is described in detail based on FIGS. 2 to 5C.

The bracket 20 includes: a mounting part 25 that is formed in the shape of a triangular plate; a first leg part 26 that protrudes downward from the front end of a lower part of the mounting part 25; and a second leg part 27 that protrudes toward left from the rear end of the lower part of the mounting part 25.

The triangular mounting part 25 is constituted of: a front side 25a that extends in the vertical direction; a lower side 25b that extends in the front-rear direction; and an inclined side 25c that obliquely connects the upper end of the front side 25a and the rear end of the lower side 25b, and a triangular lightening hole 25d for lightening the mounting part is formed so as to be surrounded by the front side 25a, the lower side 25b, and the inclined side 25c. The lightening hole 25d is not necessarily essential, and may be omitted depending on a balance between the weight and strength of this part.

A first boss part 25e whose lateral length is relatively short is formed in an intermediate part in the vertical direction of the front side 25a of the mounting part 25, and a second boss part 25f whose lateral length is relatively long is formed in a portion where the lower side 25b and the inclined side 25c intersect. With the bolt 21 that penetrates the first boss part 25e in the lateral direction and the bolt 22 that penetrates the second boss part 25f in the lateral direction, the bracket 20 is fastened to the left side face of the high-pressure fuel pump base 14.

The first leg part 26 linearly extends downward in such a manner that the front side 25a of the mounting part 25 is extended downward, and its cross-section orthogonal to its longitudinal direction is in the shape of the letter L having: a first portion 26a that extends in the front-rear direction; and a second portion 26b that bends left at a right angle from the front end of the first portion 26a. Here, the cross-section of a lower half part of the front side 25a of the mounting part 25 that extends continuously from the first leg part 26 has the same L shape as the first leg part 26. A horizontal first boss part 26c is formed at the lower end of the first leg part 26, and the bolt 23 that penetrates the first boss part 26c in the vertical direction is fastened to a first boss part 16b that is placed on an upper face of the intake pipe 16.

The second leg part 27 protrudes left from the vicinity of the second boss part 25f of the mounting part 25, and its cross-section orthogonal to its longitudinal direction is in the shape of the letter L having: a first portion 27a that extends in the front-rear direction; and a second portion 27b that bends upward at a right angle from the front end of the first portion 27a. A horizontal second boss part 27c is formed at the left end of the second leg part 27, and the bolt 24 that penetrates the second boss part 27c in the vertical direction is fastened to a second boss part 16c that is placed on the upper face of the intake pipe 16.

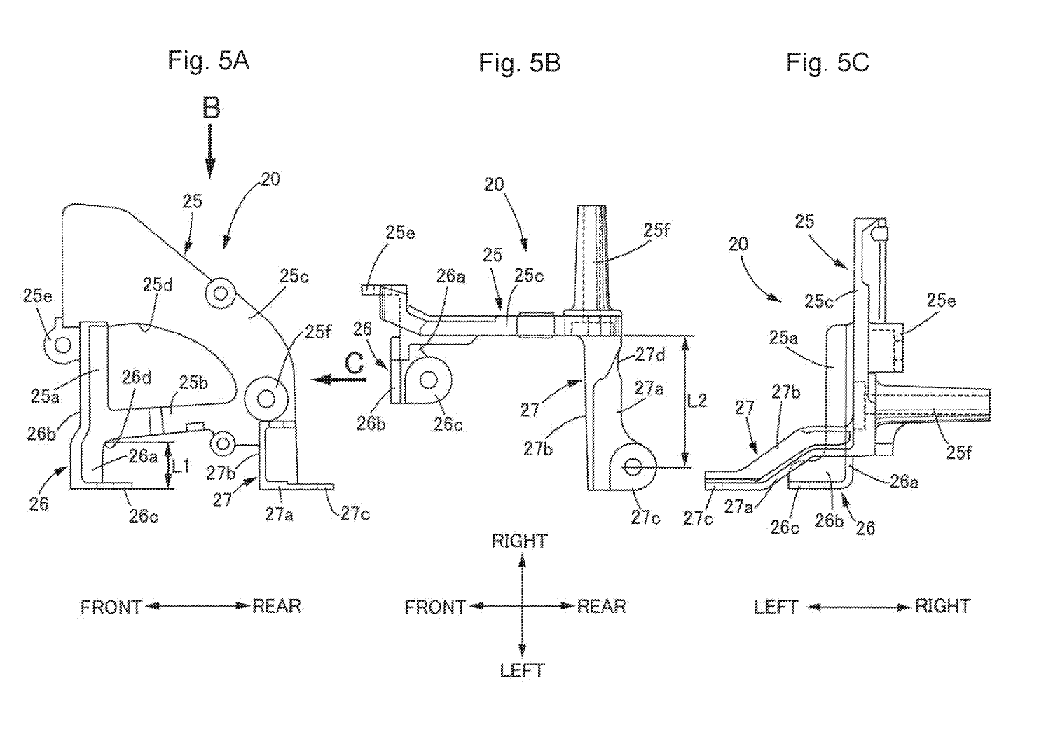

A protrusion length L2 by which the second leg part 27 protrudes left from the mounting part 25 is set larger than a protrusion length L1 by which the first leg part 26 protrudes downward from the mounting part 25 (see FIGS. 5A and 5B). In addition, since the first leg part 26 extends downward from the mounting part 25 and the second leg part 27 extends left from the mounting part 25, the position of the first boss part 26c located at the tip of the first leg part 26 is displaced in the lateral direction from the position of the second boss part 27c located at the tip of the second leg part 27.

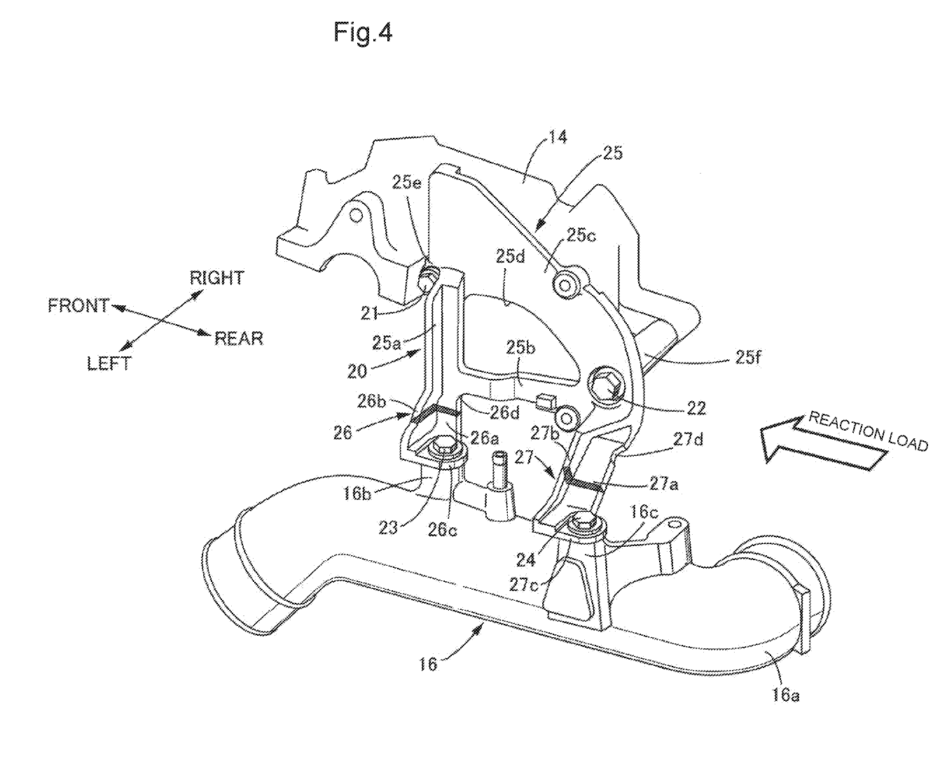

At a portion where the upper end of the first leg part 26 is connected to the mounting part 25, a rear edge of the first portion 26a of the first leg part 26 is connected to the mounting part 25 via a corner part 26d (see FIGS. 4 and 5(A)) having a small radius of curvature, and this corner part 26d constitutes a brittle part where stress concentration easily occurs. In addition, at a portion where the right end of the second leg part 27 is connected to the mounting part 25, a constriction part 27d (see FIGS. 4 and 5B) is formed by notching a rear edge of the first portion 27a of the second leg part 27 in an arc shape and slimming it down, and this constriction part 27d constitutes a brittle part where the cross-sectional area of the second leg part 27 is reduced locally and thus stress concentration easily occurs.

As illustrated in FIG. 2, the high-pressure fuel pump base 14 is provided with a purge control solenoid 28 that controls the opening/closing of a fuel purge line designed to let fuel vapor generated in a fuel tank escape toward an intake system of the engine, and the purge control solenoid 28 is covered with the mounting part 25 of the bracket 20 secured on the high-pressure fuel pump base 14.

Next, a description is given of an operation of the embodiment of the present disclosure having the above configuration.

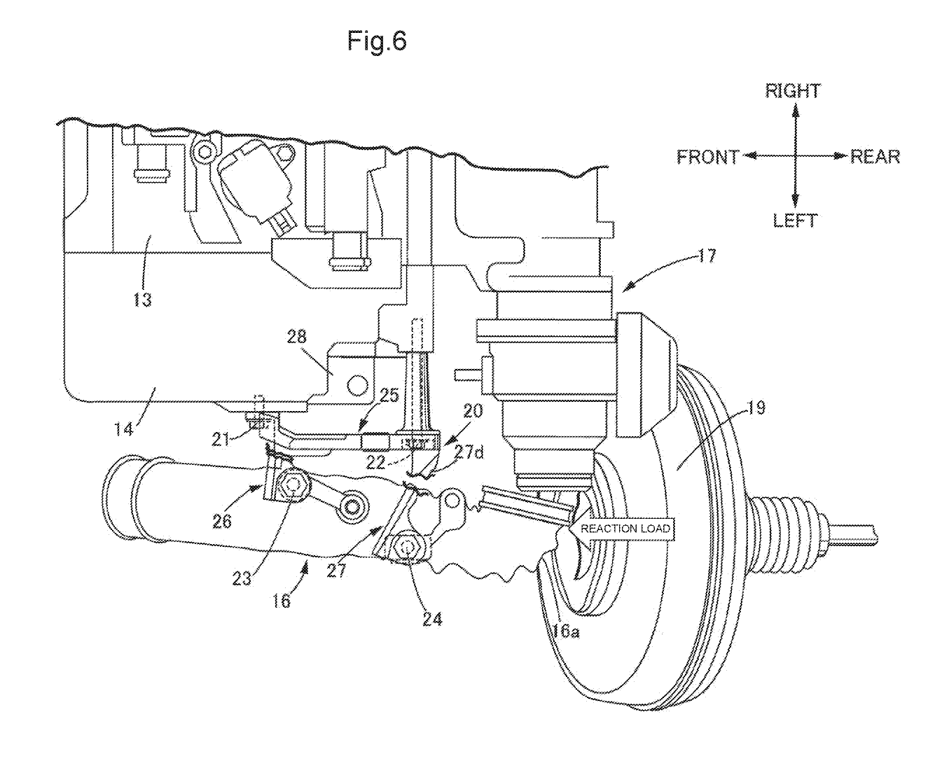

As illustrated in FIG. 6, when a vehicle collides at its front and the engine is moved back by a collision load, the bend part 16a located at the rear end of the intake pipe 16 supported by the engine is brought into contact with the negative-pressure booster 19 supported by the dash panel 18, and the intake pipe 16 is moved forward relative to the engine by receiving a forward reaction load from the negative-pressure booster 19.

At this time, since the mounting part 25 of the bracket 20 is firmly secured on the high-pressure fuel pump base 14 with the two bolts 21, 22, tip parts of the first leg part 26 and the second leg part 27 of the bracket 20 that are secured on the intake pipe 16 with the bolts 23, 24 are pushed forward by a reaction load, and stress concentration occurs at proximal end parts of the first leg part 26 and the second leg part 27 where these leg parts communicate with the mounting part 25. In particular, since a large tensile load generated due to the forward reaction load acts on the rear edges of the first portions 26a, 27a extending in the front-rear direction in the cross-sections of the first leg part 26 and the second leg part 27, stress concentration occurs at the corner part 26d that is formed at the rear edge of the first portion 26a of the first leg part 26 and the constriction part 27d that is formed at the rear edge of the first portion 27a of the second leg part 27, and thus the first leg part 26 and the second leg part 27 are broken at these portions and separated from the mounting part 25 reliably.

Once the first leg part 26 and the second leg part 27 are broken in this way, the intake pipe 16 is separated from the bracket 20 and thus the reaction force acting on the intake pipe 16 no longer acts on the mounting part 25 of the bracket 20, thereby preventing breakage of the mounting part 25 of the bracket 20 and the high-pressure fuel pump base 14 having the bracket 20 mounted thereon. Accordingly, it is possible to protect, against the reaction load, the purge control solenoid 28 that is sandwiched between the high-pressure fuel pump base 14 and the mounting part 25 of the bracket 20.

In addition, thanks to high rigidity of the first leg part 26 and the second leg part 27 that have the L-shaped cross-sections composed of the first portions 26a, 27a and the second portions 26b, 27b extending in the directions orthogonal to each other, these leg parts can firmly support the intake pipe 16 at normal times other than at the time of vehicle collision, and besides, when a forward reaction load is input from the intake pipe 16 due to vehicle collision, it is possible to reliably break the corner part 26d of the first leg part 26 and the constriction part 27d of the second leg part 27, which are the brittle parts, by making a strong tensile load act on the rear edges of the first portions 26a, 27a, which extend in the front-rear direction, to trigger the breakage of the leg parts.

Moreover, since the first leg part 26 and the second leg part 27 are displaced from each other in the front-rear direction, the first boss part 26c at the tip of the first leg part 26 and the second boss part 27c at the tip of the second leg part 27, which are fastened to the intake pipe 16, are spaced apart from each other in the front-rear direction. Besides, since the first leg part 26 extends downward from the mounting part 25 and the second leg part 27 extends left from the mounting part 25, the first boss part 26c of the first leg part 26 and the second boss part 27c of the second leg part 27 are spaced apart from each other in the lateral direction. This makes it possible to increase their rigidity to support the intake pipe 16 under loads in various directions, and thus to prevent vibration of the intake pipe 16 with the first leg part 26 and the second leg part 27 thinned and lightened.

Further, the protrusion length L2 by which the second leg part 27 protrudes from the mounting part 25 is set larger than the protrusion length L1 by which the first leg part 26 protrudes from the mounting part 25. Thus, it is possible to break the second leg part 27 first when a forward reaction load is input from the intake pipe 16, by making large stress concentrate on the constriction part 27d that is formed at the proximal end of the second leg part 27 having a long moment arm. Once the second leg part 27 is broken in this way, all the reaction load then concentrates on the first leg part 26, thereby making it possible to reliably break the first leg part 26 following the second leg part 27.

Furthermore, since aluminum being the material of the bracket 20 is more brittle and less ductile than iron, it is broken at once with hardly any plastic deformation upon application of stress larger than a predetermined value. This facilitates breakage control over the first leg part 26 and the second leg part 27.

The embodiment of the present disclosure has been described above; however, various design changes can be made on the present disclosure without departing from the gist thereof.

For example, the engine body of the present disclosure is not limited to the high-pressure fuel pump base 14 of the embodiment, and may be a cylinder head or a cylinder block.

In addition, the brake component of the present disclosure is not limited to the negative-pressure booster 19 of the embodiment.

Moreover, although the bracket 20 of the embodiment has the two leg parts (the first leg part 26 and the second leg part 27), the number of leg parts may be one or more than three.

Further, although the first leg part 26 extends downward from the mounting part 25 and the second leg part 27 extends left from the mounting part 25 in the embodiment, the first leg part 26 and the second leg part 27 may extend in any direction from the mounting part 25.

Furthermore, the brittle parts of the present disclosure are not limited to the corner part 26d and the constriction part 27d of the embodiment, and any parts susceptible to stress concentration may be employed.

In addition, although the first leg part 26 and the second leg part 27 each have the L-shaped cross-section in the embodiment, any cross-sectional shape may be employed.

Moreover, although the bracket 20 of the embodiment is made of aluminum, any material other than aluminum may be selected. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

1. An intake pipe supporting structure comprising:
a bracket provided to an engine body;
an intake pipe supported by the bracket and extending in a front-rear direction of a vehicle; and
a brake member provided to a dash panel so as to be located behind said intake pipe,
wherein said bracket comprises:
a mounting part mounted to said engine body; and
a leg part protruding from said mounting part and fastened to said intake pipe, and
said leg part includes a brittle part that is broken when a load is input from said brake member to said intake pipe.

2. The intake pipe supporting structure according to claim 1, wherein said brittle part is a corner part that is provided to a rear side of a connection portion of said leg part where said leg part is connected to said mounting part.

3. The intake pipe supporting structure according to claim 1, wherein said brittle part is a constriction part where a cross-sectional area of said leg part is reduced locally.

4. The intake pipe supporting structure according to claim 1, wherein said leg part has an L-shaped cross-section including:
a first portion that extends in the front-rear direction; and
a second portion that extends from a front end of said first portion in a direction orthogonal to the front-rear direction.

5. The intake pipe supporting structure according claim 1, wherein
said leg part comprises a first leg part in a front portion thereof and a second leg part in a rear portion thereof, and
said first leg part and said second leg part each include said brittle part.

6. The intake pipe supporting structure according to claim 5, wherein said second leg part has a longer length than that of said first leg part.

7. The intake pipe supporting structure according to claim 5, wherein one of said first leg part and said second leg part extends in a vertical direction from said mounting part, and the other of said first leg part and said second leg part extends in a lateral direction from said mounting part.

8. The intake pipe supporting structure according to claim 1, wherein said bracket is made of aluminum.

9. The intake pipe supporting structure according to claim 1, wherein the brittle part is disposed at a proximal end of the leg part.

10. The intake pipe supporting structure according to claim 1, wherein the bracket is provided on a left side or a right side of the engine body.

11. The intake pipe supporting structure according to claim 10, wherein the intake pipe is provided on the left side or the right side of the engine body.

12. The intake pipe supporting structure according to claim 1, wherein the leg part is configured to be weaker against the load applied from rear direction than the load applied from other direction.

13. The intake pipe supporting structure according to claim 1, wherein the intake pipe is disposed such that the intake pipe is overlapped with the brake member when viewed along the front-rear direction.

14. A vehicle comprising the intake pipe supporting structure according to claim 1.
